(19) United States
(12) Patent Application Publication
(10) Pub. No.: US 2026/0149561 A1
(43) Pub. Date: May 28, 2026

(54) COMBINED COUNTERMEASURE AGAINST SIDE-CHANNEL ANALYSIS (SCA)

(71) Applicant: TELEFONAKTIEBOLAGET LM ERICSSON (PUBL), STOCKHOLM (SE)

(72) Inventors: Niklas Lindskog, Lund (SE); Håkan Englund, Lund (SE); Elena Dubrova, Sollentuna (SE); Martin Brisfors, Kista (SE); Michail Moraitis, Solna (SE)

(21) Appl. No.: 19/122,913

(22) PCT Filed: Oct. 19, 2023
(86) PCT No.: PCT/IB2023/060592

§ 371 Date: Apr. 21, 2025

Related U.S. Application Data
(60) Provisional application No. 63/418,340, filed on Oct. 21, 2022.

(51) Int. Cl. H04L 9/00

(52) U.S. Cl. CPC H04L 9/005

(57) ABSTRACT

Systems and methods described herein provide for a processing unit that generates side-channel countermeasures to protect sensitive information. The processing unit can include two circuits, a primary circuit and a countermeasure circuit that each process the same input but each circuit can be configured by respective randomized clock signals and respective secrets or secret keys. The secret key used by the countermeasure circuit, can be a different secret than the secret used by the first circuit, but it can be based on the secret used by the first circuit. The output of the cryptographic algorithm of the first circuit can have an associated side-channel leakage or emission (power consumption, electromagnetic radiation, sound, vibration, temperature variation, etc.). The countermeasure circuit's side-channel leakage can obscure the first circuit's side-channel leakage or make it difficult to interpret the side-channel leakage of the first circuit.

### RELATED APPLICATIONS

This application claims the benefit of provisional patent application Ser. No. 63/418,340, filed Oct. 21, 2022, the disclosure of which is hereby incorporated herein by reference in its entirety.

### TECHNICAL FIELD

The present disclosure relates to a method for employing combined countermeasures against side-channel analyses, and a processing device that can employ the method.

### BACKGROUND

### Side-Channel Analysis (SCA)

Side-channel leakage/emission is defined as a non-intended information channel from a device. The side-channel can consist of e.g., power consumption, electromagnetic (EM) emissions, timing, thermal signatures, sound, and optical emissions. An attacker can utilize these leakages to extract sensitive information from a device, e.g., to extract a key utilized to encrypt information, or to extract weights of deep-learning models which are run on the device in order to clone them, or to deduce information about the (possibly confidential) training data which was used to train them. While the former is an acute problem at present, the latter might become an issue in the future, when AI algorithms will be a natural part of many systems.

Side-channel attacks work because there is a correlation between the physical measurements (power consumption, EM emissions, timing, etc.) taken at different points during the data dependent computations of the processing device. For example, the power consumption can be correlated to the Hamming weight (number of binary ‘1’s) of data propagated on a bus, or to the Hamming distance between the current and the previous state of the device. Finding this correlation enables the side-channel attacks to deduce the internal state and then extract the related sensitive information, e.g., the secret key of a crypto algorithm.

Side-channel attacks are proven to be several orders of magnitude more effective than the conventional mathematical cryptanalysis and much more practical to mount. They do not require expensive equipment, like invasive physical attacks. Furthermore, with advances in machine learning, a more powerful side-channel attacks emerged. Since machine learning techniques are good at finding correlations in raw data, they enable the adversary to bypass many existing countermeasures and break some protected implementations.

In the past years, many types of side channels have been successfully exploited to break physical implementations of many cryptosystems. Examples include implementations of cryptographic algorithms such as Advanced Encryption Standard (AES) and Post-Quantum Cryptography (PQC)-candidates Saber and CRYSTALS-Kyber. There have also been reports where side-channel attacks were used to steal intellectual property and reverse-engineer neural networks.

### Clock Randomization

Clock randomization is one of the oldest countermeasures against side-channel attacks. Various implementations of randomized clocks have been presented in the past, along with their security evaluations. A randomized clock is a clock which is designed to deliver rising/falling edges randomly within a varying within an interval rather than with a fixed frequency. To exemplify with a toy example: A standard clock may deliver a frequency of 100 MHz, i.e., a rising/falling edge every 10 nanoseconds. A randomized clock which operates the range [50-200 MHz] may first deliver 2 rising/falling edges during 10 nanoseconds, then 1 rising/falling edge during the next 20 nanosecond, then 1 rising/falling edge during the next 15 nanoseconds, etc.

However, it has been shown recently that it is possible to break countermeasures based on a randomized clock by: sampling side-channel measurements at a frequency much higher than the frequency of the clock of the targeted implementation, pre-processing the resulting traces to synchronize them, and selecting the attack point in the beginning of the execution of the algorithm run by the implementation.

For example, the deep learning-based side-channel attack on a Field Programmable Gate Array (FPGA) implementation of AES, protected by a randomized clock can recover a byte of the secret key from less than 500 power traces. Any randomized clock countermeasure is significantly weakened by an attack on the first round (or, more generally, an attack which targets the beginning of the execution of the algorithm) because the effect of randomness accumulated over multiple encryption rounds is lost.

### Duplication

Duplication is a technique which was originally introduced in fault-tolerant design to detect random faults. Two identical modules operate in parallel, their results are compared using a comparator. If the results disagree, an error signal is generated. Depending on the application, the duplicated modules can be processors, memories, busses, and so on.

Later, duplication was adopted as a countermeasure against fault injection attacks on implementations of cryptographic algorithms. The idea of a fault injection attack is to inject into the implementation of the algorithm a physical fault (e.g., by a laser, glitching, etc.) which causes an exploitable error in the algorithm's computation. For example, if the keystream generating output of a stream cipher is stuck to 0, then the plaintext to be encrypted will be transmitted unencrypted, since it will be combined with an all-0 keystream rather than the expected keystream.

There were attempts in the past to use duplication as a countermeasure against side-channel analysis. It has been proposed to protect AES from power/EM analysis by a duplication with complementation scheme in which the duplicated module implements the complemented version of AES, both versions take as input the same plaintext and the same secret key, and the resulting ciphertexts are compared using a comparator. If the ciphertexts disagree, an error signal is generated. In the complemented version of AES, each line Lc in the implementation has the value x′ which is the Boolean complement (NOT) of the value x on the corresponding line L in the non-complementary implementation of AES, x′=NOT (x). Since both lines (L, Lc) always have a constant Hamming weight 1, the total Hamming weight of the internal state of the algorithm is constant and equal to the number of bits of the state, n. The Hamming weight (HW) of a binary vector S is defined as the number of 1's in S. Since the total power consumption is proportional to the HW of the internal state in some implementations, it was assumed that the duplication with complementation scheme can be used as a countermeasure against power/EM analysis.

However, it has been shown that such an assumption may not be correct because the total power consumption may also be proportional to the Hamming distance between the current state S1 and the previous state S2. The Hamming distance (HD) of two binary vectors S1 and S2 is defined as the number of bit positions in which S1 and S2 differ. If an implementation uses the duplication with complementation scheme, then its respective internal state has the structure of type (S1, S1′) and (S2, S2′). While the HW of any internal state is n, the HD between (S1, S1′) and (S2, S2′) is twice the HD between S1 and S2, or S1′ and S2′. The example below illustrates why this is the case for states of size n=3:

$$S 1 = ( 001 ) , S {1}^{′} = ( 110 ) , HW ( S 1 , S {1}^{′} ) = 3$$

$$S 2 = ( 010 ) , S {1}^{′} = ( 101 ) , HW ( S 2 , S {2}^{′} ) = 3$$

$$HD ( S 1 , S 2 ) = 2 , HD ( S {1}^{′} , S {2}^{′} ) = 2 , HD ( ( S 1 , S {1}^{′} ) , ( S 2 , S {2}^{′} ) ) = 4$$

Since HD doubles, power/EM analysis of the implementations whose total power consumption is proportional to the HD between the internal states becomes easier.

The Correlation Power Analysis (CPA)-based side-channel attack needs three times less power traces to extract the secret key from an FPGA implementation of AES based on the duplication with comparison than the attack on an FPGA implementation of AES without the duplication with comparison.

### SUMMARY

Systems and methods described herein provide for a processing unit that generates side-channel countermeasures to protect sensitive information. The processing unit can include two circuits, a primary circuit and a secondary circuit that each process the same input to using, e.g., a cryptographic algorithm, but each circuit can be configured by respective randomized clock signals and respective secrets or secret keys. The secret key used by the secondary, or countermeasure circuit, can be a different secret than the secret used by the first circuit, but it can be based on the secret used by the first circuit. The output of the cryptographic algorithm of the first circuit can have an associated side-channel leakage or emission (power consumption, electromagnetic radiation, sound, vibration, temperature variation, etc.). The countermeasure circuit can also produce an output which is discarded, but the countermeasure circuit's side-channel leakage can obscure the first circuit's side-channel leakage or make it difficult to interpret the side-channel leakage of the first circuit.

In an embodiment, a method performed by a processing unit for generating side-channel countermeasures to protect sensitive information is provided. The method includes configuring a first circuit with a first secret. The method can also include configuring a countermeasure circuit with a countermeasure secret, supplying a first randomized clock signal to the first circuit, and supplying a second randomized clock signal to the countermeasure circuit. The method can also include processing an input at the first circuit based on the first randomized clock signal and the first secret to generate a first output and a first side-channel leakage; and processing the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.

In an embodiment, the first circuit and the countermeasure circuit are identical circuits.

In an embodiment, the first circuit and the countermeasure circuit are different circuits and generate respective side-channel leakage profiles that are similar within a predefined threshold.

In an embodiment, the first circuit is a first machine learning model and wherein the first secret is a function of an architecture of the first machine learning model and parameters of the first machine learning model.

In an embodiment, the countermeasure circuit is a second machine learning model with parameters based on the parameters of the first machine learning model.

In an embodiment, the countermeasure secret is based on an output of a generator component that utilizes the first secret as an input.

In an embodiment, the countermeasure secret is based on an output of a generator component that utilizes the information associated with the first secret as an input.

In an embodiment, the generator component is at least one of a pseudo-random number generator, a message authentication code function, or a physical unclonable function, or a hash function.

In an embodiment, the countermeasure secret is based on an input to the processing unit.

In an embodiment, the first secret and the countermeasure secret are configured as a pair.

In an embodiment, the method includes processing the input at a plurality of different countermeasure circuits that are supplied with respective countermeasure secrets.

In an embodiment, the first randomized clock signal and the second randomized clock signal are generated by a single randomized clock circuit.

In an embodiment, the first circuit is a cryptographic algorithm and wherein the first secret is a cryptographic key.

In an embodiment, the countermeasure circuit is a second cryptographic algorithm, and the countermeasure secret is a cryptographic key.

In an embodiment, a processing unit that includes processing circuitry is provided. The processing circuitry can be configured to configure a first circuit with a first secret. The processing circuitry can also configure a countermeasure circuit with a countermeasure secret. The processing circuitry can also supply a first randomized clock signal to the first circuit. The processing circuitry can also supply a second randomized clock signal to the countermeasure circuit. The processing circuitry can also process an input at the first circuit based on the first randomized clock signal and the first secret to generate a first output and a first side-channel leakage and process the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.

Certain embodiments may provide one or more of the following technical advantage(s). One embodiment compromises a countermeasure side-channel leakage which makes it very difficult for an attacker to extract any information from the side-channel leakage of the first circuit due to the difficulty of distinguishing which trace or side-channel measurement belongs to which process.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram illustration of a processing unit 100 that generates side-channel countermeasures to protect sensitive information according to one or more embodiments of the present disclosure;

FIG. 2 illustrates a flowchart of a method for generating side-channel countermeasures to protect sensitive information according to one or more embodiments of the present disclosure;

FIG. 3 shows an example of a communication system 300 in which the processing element 100 can be employed in accordance with some embodiments;

FIG. 4 shows a User Equipment (UE) 400 in accordance with some embodiments; and

FIG. 5 shows a network node 500 in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Clock randomization and duplication with comparison do not provide an adequate protection against side-channel attacks if implemented alone.

Certain aspects of the disclosure and their embodiments may provide solutions to these or other challenges. The present disclosure proposes a countermeasure against side-channel attacks comprising a combination of two distinct countermeasures: clock randomization and duplication.

As described in the background section, each of these countermeasures is known to be flawed if used standalone. However, by combining them in the proposed way, the combination becomes stronger than its parts.

The weakness of the clock randomization comes from the fact that, with a sufficient oversampling rate, one can synchronize traces representing the side-channel measurements. This cancels out the advantages of clock randomization.

The weakness of the duplication comes from the fact that simply using a duplicated circuit doubles the total power consumption of the implementation, making its power/electromagnetic (EM) analysis easier.

However, when these two countermeasures are combined together in a specific way, it becomes very difficult to distinguish which segments of power traces are generated by the first circuit, and which—by the duplicated circuit. By preventing an attacker from distinguishing which power trace belong to respective circuit, the attacker is unable to mount a successful side-channel analysis.

The present disclosure can comprise two separate circuits. The circuits may, e.g., be implemented in hardware, e.g., as a part of an Application Specific Integrated Circuit (ASIC) or in reconfigurable hardware, e.g., as a part of a Field Programmable Gate Array (FPGA).

A first circuit comprises a randomized clock and a unit implementing an algorithm which operates on a secret. A second circuit comprises a randomized clock and a unit implementing an algorithm which operates on a value derived from the secret, called the “countermeasure secret”. To disable the attacker from filtering out the second circuit as noise, the countermeasure secret can be based on the first secret and thereby be deterministic.

The algorithms implemented by the first circuit and the second circuit can be a cryptographic algorithm such as Advanced Encryption Standard (AES) or Crystals-KYBER, but any algorithm utilizing a secret of some sort, e.g., a Machine Learning (ML) model with secret layers may utilize the implementation.

Systems and methods described herein provide for a processing unit that generates side-channel countermeasures to protect sensitive information. The processing unit can include two circuits, a primary circuit and a secondary circuit that each process the same input to using, e.g., a cryptographic algorithm, but each circuit can be configured by respective randomized clock signals and respective secrets or secret keys. The secret key used by the secondary, or countermeasure circuit, can be a different secret than the secret used by the first circuit, but it can be based on the secret used by the first circuit. The output of the cryptographic algorithm of the first circuit can have an associated side-channel leakage or emission (power consumption, electromagnetic radiation, sound, vibration, temperature variation, etc.). The countermeasure circuit can also produce an output which is discarded, but the countermeasure circuit's side-channel leakage can obscure the first circuit's side-channel leakage or make it difficult to interpret the side-channel leakage of the first circuit.

In an embodiment, the second circuit provides universal countermeasure against side-channel analysis comprising/combining clock randomization and duplication.

In an embodiment, the device has a first (primary) and at least one second (countermeasure) circuit.

In an embodiment, a randomized clock supplies a separate clock signal for both the first and countermeasure circuits or alternatively, where each circuit comprises its own randomized clock.

In an embodiment, the first and countermeasure circuits are separate instances of the same circuit or, the first and countermeasure circuits are differently implemented circuits but generate similar side-channel profiles.

In an embodiment, the first and countermeasure circuits comprise a cryptographic algorithm and utilize different cryptographic keys or alternatively, where each circuit comprises a neural network with secret parameters.

In an embodiment, the same input is supplied to both circuits.

In an embodiment, the side-channel leakage is power consumption, electromagnetic (EM) emissions, sound, vibrations, or temperature variations or any other discernible parameter that can be measured.

Certain embodiments may provide one or more of the following technical advantage(s). One embodiment compromises a countermeasure side-channel leakage which makes it very difficult for an attacker to extract any information from the side-channel leakage of the first circuit due to the difficulty of distinguishing which trace or side-channel measurement belongs to which process.

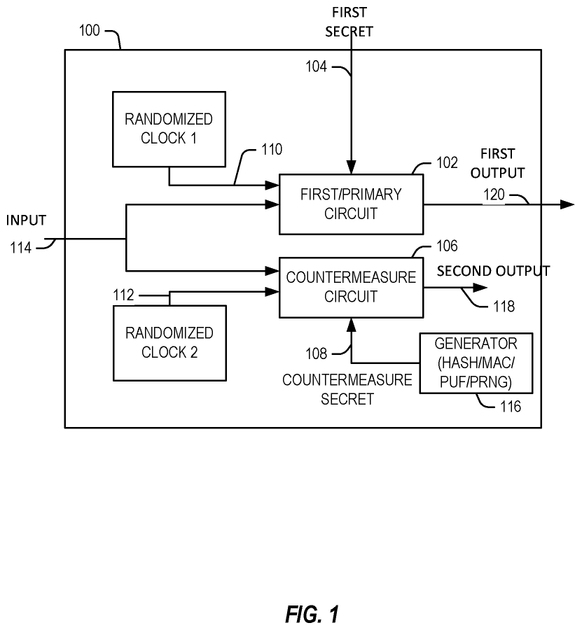

FIG. 1 is a block diagram illustration of a processing unit 100 that generates side-channel countermeasures to protect sensitive information according to one or more embodiments of the present disclosure.

The processing unit 100, is a unit within a device or system comprising at least:

A first circuit 102 implementing an algorithm involving some secret in its computation, e.g., a cryptographic algorithm with a first secret, which takes an external input 114 and produces a first output 120.

At least one second/countermeasure circuit 106 comprising either a duplicated copy of the first circuit 102, or a version of the first circuit 102 having the same or similar power profile to within a predefined threshold of variation. The countermeasure circuit 106 utilizes a second/countermeasure secret 108 in its computation and also takes input 114 as input to the countermeasure circuit 106. The countermeasure circuit 106 produces a second output 118 which is not exposed outside of the processing unit 100 and can be discarded.

In an embodiment, a randomized clock 1 is used to provide a clock signal 110 to the first circuit 102, while an optional randomized clock 2 is used to provide a second randomized clock signal 112 to the countermeasure circuit 106. In one or more embodiments, the randomized clock signals 110 and 112 can be derived from a single randomized clock that has an output that is processed via a multiplexer to obtain the separate and distinct randomized clock signals 110 and 112.

A generator component 116, can produce a deterministic or probabilistic countermeasure secret 108 based on the first secret 104. The countermeasure secret 108 can be used to configure the countermeasure circuit 106. In an embodiment, the generator component 116 may be implemented using at least one of a Pseudo-Random Number Generator (PRNG) function, a hash function, a Message Authentication Code (MAC) function, or a Physically Unclonable Function (PUF).

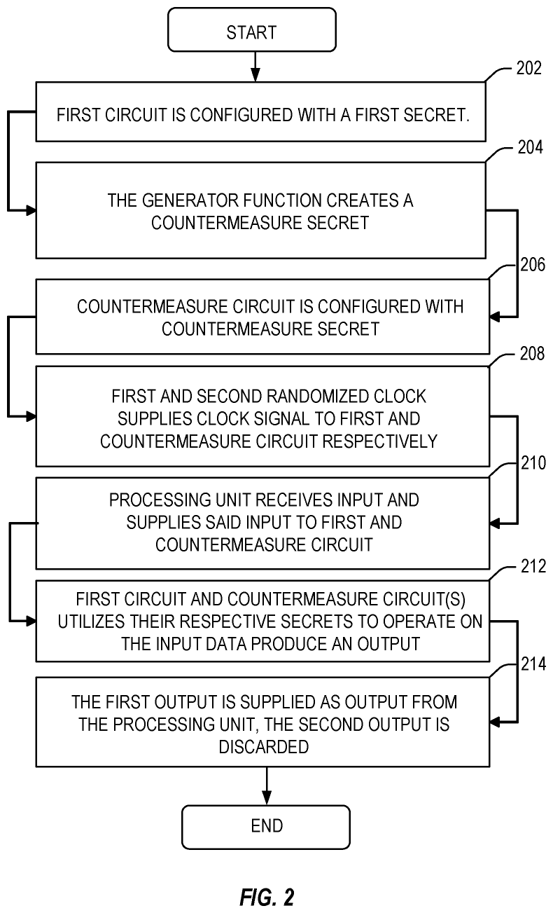

The present disclosure shows how these components interact in FIG. 1 and describe the general flow of the present disclosure in FIG. 2.

FIG. 2 illustrates a flowchart of a method for generating side-channel countermeasures to protect sensitive information according to one or more embodiments of the present disclosure.

The method can start at step 202, where the method includes configuring the first circuit 102 with a first secret 104. In one embodiment, the first secret 104 is not supplied to the generator explicitly but rather the generator component 116 may instead receive an ID connected to the first secret 104.

In another embodiment, the countermeasure secret is explicitly fed to the countermeasure circuit 106. In this case, the user is responsible for deterministically selecting a pair of secrets {first, countermeasure}. In such an embodiment, step 204 may be skipped.

At step 204, the generator component 116 creates a countermeasure secret. The countermeasure secret 108 can be a function of the first secret 104, where the first secret 104 is an input to a generator component 116. The generator component 116, can produce a deterministic or probabilistic countermeasure secret 108 based on the first secret 104. The countermeasure secret 108 can be used to configure the countermeasure circuit 106. In an embodiment, the generator component 116 may be implemented using at least one of a Pseudo-Random Number Generator (PRNG) function, a hash function, a Message Authentication Code (MAC) function, or a Physically Unclonable Function (PUF)

At step 206, the countermeasure circuit 106 is configured with the countermeasure secret 108.

At step 208, the first and second randomized clocks supplies respective clock signals 110 and 112 to the first circuit 102 and countermeasure circuit 106, respectively. In an embodiment the randomized clock signals 110 and 112 can be derived from a single randomized clock that has an output that is processed via a multiplexer to obtain the separate and distinct randomized clock signals 110 and 112.

At step 210, the processing unit 100 receives the input 114 and supplies the input 114 to the first circuit 102 and the countermeasure circuit 106.

At step 212, the first circuit 102 and the countermeasure circuit 106 utilize their respective secrets 104 and 108 to operate on or process the input 114 to produce the outputs 116 and 118 using the cryptographic algorithm(s) of the first circuit 102 and the countermeasure circuit 106. In addition to the outputs 116 and 118, the first circuit 102 and countermeasure circuit 106 also produce respective side-channel leakages. The side-channel leakage from the countermeasure circuit 106 can obscure or make it difficult to use the side-channel leakage from the first circuit to determine secret information or information associated with output 116. In an embodiment, the processing unit 100 can comprise a plurality of different countermeasure circuits 106 that each process the input 114 at the plurality of different countermeasure circuits 106 that are supplied with respective countermeasure secrets to produce a plurality of side-channel leakages to further obscure the side-channel leakage of the first circuit 102.

At step 214, the first output 120 is supplied as output from the processing unit 100, and the second output 118 can be discarded or otherwise not used for anything else other than the associated side-channel leakage with the second output 118.

Far from any combination of clock randomization and duplication results in a secure solution. The present disclosure has as the following four distinct features which make the combination secure:
1) Similar trace shape: By using a copy of the first circuit 102, or a version of the first circuit 102 with the same power profile, the duplicated circuit generates power/EM traces with the same shape as the first circuit.
2) No extra key-dependent leakage: By feeding a non-correlated countermeasure key or secret 108 into the duplicated circuit, rather than the first secret 104 of the first circuit 102, no additional secret key-related leakage is created during the execution of the algorithm.
3) Same known input: By feeding the same known input into both circuits, e.g., the plaintext for an encryption algorithm, the attacker cannot identify and filter out the segments of traces generated by the duplicated circuit by e.g., correlating the measurements to the plaintext.
4) Algorithmic noise: By connecting the process of countermeasure key generation to the secret key of the first circuit, the same dummy key Kd is used in a pair with a given secret key K. The countermeasure key is updated only if the original secret key K is updated. As a result, in combination with feature (3), the noise generated by the duplicate circuit is algorithmic, rather than random. If the countermeasure secret 108 were changed at every execution of the algorithm, the attacker could filter out the segments of traces generated by the duplicated circuit in the same way as random noise is filtered out, i.e., by averaging many repeated measurements for the same input plaintext.

To summarize, these four features assure that the countermeasure circuit creates an algorithmic noise dependent on the same known input parameters and having the same shape of power/EM traces as the first circuit. At the same time, it does not create any extra key-dependent leakage.

A brute force attack would require at least 2^{m} enumerations where m is the number of captured traces. Hence, it becomes computationally infeasible to apply a synchronization technique in order to synchronize misaligned traces generated by an implementation with a randomized clock. The existing techniques for power/EM analysis, including Correlation Power Analysis (CPA), template attacks, and deep learning-based attacks, cannot extract a secret key from misaligned traces if the dis-synchronization exceeds a certain level.

In one embodiment, the first circuit 102 is a machine learning model comprising secret parameters, such as a proprietary neural network. In this case, the first secret 104 may be both the architecture and the parameters in the model, such as weights for each neuron.

In such an embodiment, the countermeasure circuit 106 is a machine learning model with parameters derived from the parameters in the first circuit 102.

In one embodiment, the countermeasure circuit 106 is not equal to the first circuit 102 but produces a similar or equal power trace. The countermeasure circuit 106 may be implemented to require less area and therefore only implement the parts of the first circuit 102 which may leak information regarding the secret.

In one embodiment, the countermeasure secret 108 is derived using both the first secret 104 and a device-unique component, meaning that, given the same first secret, the countermeasure secret will be different for each device it is implemented on. This gives the additional benefit of an attacker being unable to replicate the same behavior on a separate device, which is the pre-requisite of so-called template attacks, where the attacker minimizes the traces needed to extract the secret by training on one or several equal devices.

The device-unique component may be a device-unique parametrization of the generator component 116, where the generated is embodied as a One-Way Function (OWF). The OWF receives both the first secret and a deterministic, device-unique value as input. The component may instead and/or also include be using a Physically Unclonable Function (PUF) as the generator component 116 which in itself is device-unique and probabilistic. By adding an error correction component to the PUF, it can be seen as deterministic.

Such an embodiment provides an additional level of protection as an attacker is not able to mount attacks trying to distinguish between the traces belonging to the first circuit 102 and the countermeasure circuit 106 on any other device.

In one embodiment, the present disclosure may comprise more than one countermeasure circuit. Each countermeasure circuit 106 will be given its own deterministic countermeasure secret 108 either based directly such as:

$$Countermeasure\_secret \_ 1 = Generator ( first\_secret , parameter 1 )$$

$$Countermeasure\_secret \_ 2 = Generator ( first\_secret , parameter 2 )$$

or by secret chaining such as:

$$Countermeasure\_secret \_ 1 = Generator ( first\_secret )$$

$$Countermeasure\_secret \_ 2 = Generator ( countermeasure\_secret \_ 1 )$$

In one embodiment, the first circuit 102 and the countermeasure circuit 106 may have access to the same components. E.g., in the case where the first circuit 102 and the countermeasure circuit 106 is an AES implementation, there may exist two sets of S-box implementation. Upon startup and/configuration of the circuit, it may be selected which circuit that utilizes each component.

This may, for example, be solved by having multiplexers in the design which can be configured to switch between the circuits.

In one embodiment, a single randomized clock is used for both the first circuit 102 and the countermeasure circuit 106. Both circuits receive their own individual clock signal from the randomized clock, e.g., by letting the output from the clock pass through a multiplexer, randomizing which circuit receives the rising/falling edge.

In one embodiment, the first secret 104 is not supplied to the generator component 116 explicitly. The generator component 116 may instead receive an ID connected to the first secret 104.

In another embodiment, the countermeasure secret 108 is explicitly fed to the countermeasure circuit. In this case, the user is responsible for deterministically selecting a pair of secrets {first, countermeasure}.

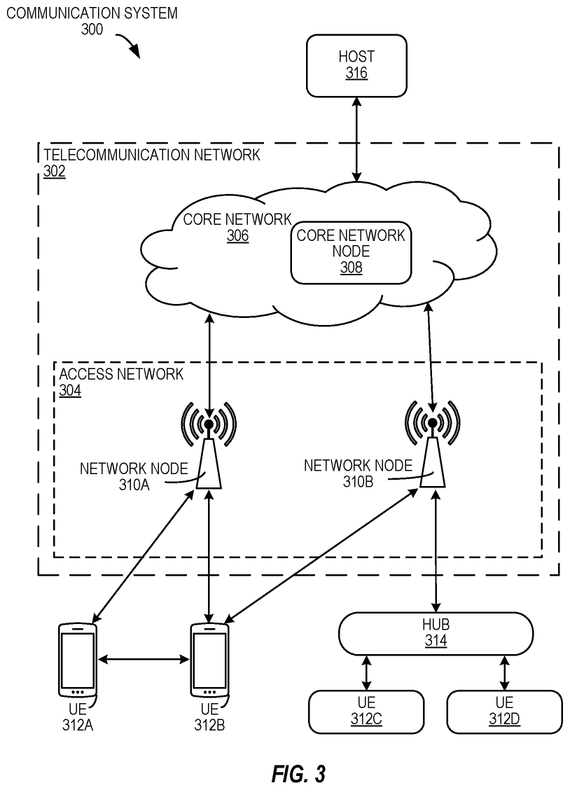

FIG. 3 shows an example of a communication system 300 in which the processing element 100 can be employed in accordance with some embodiments.

In the example, the communication system 300 includes a telecommunication network 302 that includes an access network 304, such as a Radio Access Network (RAN), and a core network 306, which includes one or more core network nodes 308. The access network 304 includes one or more access network nodes, such as network nodes 310A and 310B (one or more of which may be generally referred to as network nodes 310), or any other similar Third Generation Partnership Project (3GPP) access node or non-3GPP Access Point (AP). The network nodes 310 facilitate direct or indirect connection of User Equipment (UE), such as by connecting UEs 312A, 312B, 312C, and 312D (one or more of which may be generally referred to as UEs 312) to the core network 306 over one or more wireless connections. Any of the devices that potentially handle sensitive data, such as any of the devices in the access network 304, the core network 308, or UEs 312 can employ the processing unit 100 that generate side-channel countermeasures to protect sensitive information as described above.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system 300 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 302 is a cellular network that implements 3GPP standardized features. Accordingly, the telecommunication network 302 may support network slicing to provide different logical networks to different devices that are connected to the telecommunication network 302. For example, the telecommunication network 302 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 314 communicates with the access network 304 to facilitate indirect communication between one or more UEs (e.g., UE 312C and/or 312D) and network nodes (e.g., network node 310B). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a Virtual Reality (VR) headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310B. The hub 314 may also allow for a different communication scheme and/or schedule between the hub 314 and UEs (e.g., UE 312C and/or 312D), and between the hub 314 and the core network 306. In other examples, the hub 314 is connected to the core network 306 and/or one or more UEs via a wired connection. Moreover, the hub 314 may be configured to connect to a Machine-to-Machine (M2M) service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310B. In other embodiments, the hub 314 may be a non-dedicated hub—that is, a device which is capable of operating to route communications between the UEs and the network node 310B, but which is additionally capable of operating as a communication start and/or end point for certain data channels.

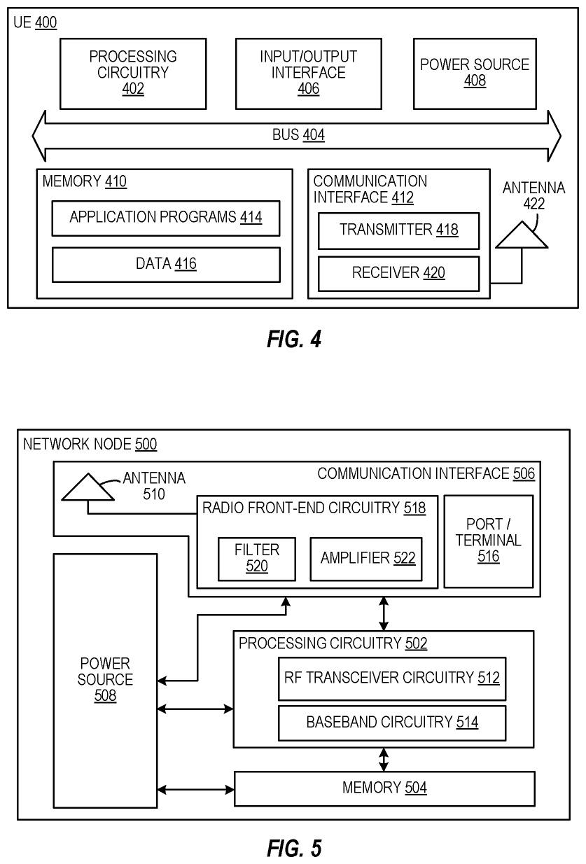

FIG. 4 shows a UE 400 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, FPGAs, ASICs, etc.); programmable logic together with appropriate firmware; one or more stored computer programs, general purpose processors, such as a microprocessor or Digital Signal Processor (DSP), together with appropriate software; or any combination of the above. For example, the processing circuitry 402 may include multiple Central Processing Units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging the power source 408. Power circuitry may perform any formatting, converting, or other modification to the power from the power source 408 to make the power suitable for the respective components of the UE 400 to which power is supplied.

The memory 410 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 410 may allow the UE 400 to access instructions, application programs, and the like stored on transitory or non-transitory memory media, to off-load data, or to upload data. An article of manufacture, such as one utilizing a communication system, may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., the antenna 422) and may share circuit components, software, or firmware, or alternatively be implemented separately.

In the illustrated embodiment, communication functions of the communication interface 412 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 412, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 5 shows a network node 500 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs). The network node 500 includes processing circuitry 502, memory 504, a

communication interface 506, and a power source 508. The network node 500 may be composed of multiple physically separate components (e.g., a Node B component and an RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 500 may be configured to support multiple RATs. In such embodiments, some components may be duplicated (e.g., separate memory 504 for different RATs) and some components may be reused (e.g., an antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 500.

The processing circuitry 502 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 500 components, such as the memory 504, to provide network node 500 functionality.

In some embodiments, the processing circuitry 502 includes a System on a Chip (SOC). In some embodiments, the processing circuitry 502 includes one or more of Radio Frequency (RF) transceiver circuitry 512 and baseband processing circuitry 514. In some embodiments, the RF transceiver circuitry 512 and the baseband processing circuitry 514 may be on separate chips (or sets of chips), boards, or units, such as radio units and digital units. In alternative embodiments, part or all of the RF transceiver circuitry 512 and the baseband processing circuitry 514 may be on the same chip or set of chips, boards, or units.

The memory 504 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and the memory 504 are integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. The radio front-end circuitry 518 comprises filters 520 and amplifiers 522. The radio front-end circuitry 518 may be connected to the antenna 510 and the processing circuitry 502. The radio front-end circuitry 518 may be configured to condition signals communicated between the antenna 510 and the processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of the filters 520 and/or the amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface 506 may comprise different components and/or different combinations of components.

In certain alternative embodiments, the network node 500 does not include separate radio front-end circuitry 518; instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes the one or more ports or terminals 516, the radio front-end circuitry 518, and the RF transceiver circuitry 512 as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, the communication interface 506, and/or the processing circuitry 502 may be configured to perform any receiving operations and/or certain obtaining operations described herein as being performed by the network node 500. Any information, data, and/or signals may be received from a UE, another network node, and/or any other network equipment. Similarly, the antenna 510, the communication interface 506, and/or the processing circuitry 502 may be configured to perform any transmitting operations described herein as being performed by the network node 500. Any information, data, and/or signals may be transmitted to a UE, another network node, and/or any other network equipment.

The power source 508 provides power to the various components of the network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid or an electricity outlet) via input circuitry or an interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some embodiments of the methods and techniques disclosed herein are as follows:
Embodiment 1: A method performed by a processing unit for generating side-channel countermeasures to protect sensitive information, the method including configuring a first circuit (102) with a first secret. The method can also include configuring a countermeasure circuit with a countermeasure secret, supplying a first randomized clock signal to the first circuit, and supplying a second randomized clock signal to the countermeasure circuit. The method can also include processing an input at the first circuit based on the first randomized clock signal and the first secret to generate a first output and a first side-channel leakage; and processing the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.
Embodiment 2: The method of embodiment 1, wherein the first circuit and the countermeasure circuit are identical circuits.
Embodiment 3: The method of embodiment 1, wherein the first circuit and the countermeasure circuit are different circuits and generate respective side-channel leakage profiles that are similar within a predefined threshold.
Embodiment 4: The method of any of embodiments 1 to 3, wherein the first circuit is a first machine learning model and wherein the first secret is a function of an architecture of the first machine learning model and parameters of the first machine learning model.
Embodiment 5: The method of embodiment 4, wherein the countermeasure circuit is a second machine learning model with parameters based on the parameters of the first machine learning model.
Embodiment 6: The method of any of embodiments 1 to 5, wherein the countermeasure secret is based on an output of a generator component that utilizes the first secret as an input.
Embodiment 7: The method of any of embodiments 1 to 5, wherein the countermeasure secret is based on an output of a generator component that utilizes the information associated with the first secret as an input.
Embodiment 8: The method of embodiment 6 to 7, wherein the generator component is at least one of a pseudo-random number generator, a message authentication code function, or a physical unclonable function, or a hash function.
Embodiment 9: The method of any of embodiments 1 to 5, wherein the countermeasure secret is based on an input to the processing unit.
Embodiment 10: The method of embodiment 9, wherein the first secret and the countermeasure secret are configured as a pair.
Embodiment 11: The method of any of embodiments 1 to 10, further comprising: processing the input at a plurality of different countermeasure circuits that are supplied with respective countermeasure secrets.
Embodiment 12: The method of any of embodiments 1-11, wherein the first randomized clock signal and the second randomized clock signal are generated by a single randomized clock circuit.
Embodiment 13: The method of any of embodiments 1 to 3, wherein the first circuit is a cryptographic algorithm and wherein the first secret is a cryptographic key.
Embodiment 14: The method of embodiment 13, wherein the countermeasure circuit (106) is a second cryptographic algorithm, and the countermeasure secret is a cryptographic key.
Embodiment 15: A processing unit, comprising processing circuitry configured to generate side-channel countermeasures to protect sensitive information, wherein the processing circuitry is configured to configure a first circuit with a first secret. The processing circuitry can also configure a countermeasure circuit with a countermeasure secret. The processing circuitry can also supply a first randomized clock signal to the first circuit. The processing circuitry can also supply a second randomized clock signal to the countermeasure circuit. The processing circuitry can also process an input at the first circuit based on the first randomized clock signal and the first secret to generate a first output and a first side-channel leakage and process the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.
Embodiment 16: The processing unit of embodiment 15, wherein the first circuit and the countermeasure circuit are identical circuits.
Embodiment 17: The processing unit of embodiment 15, wherein the first circuit and the countermeasure circuit are different circuits and generate respective side-channel leakage profiles that are similar within a predefined threshold.
Embodiment 18: The processing unit of any of embodiments 15 to 17, wherein the first circuit is a first machine learning model and wherein the first secret is a function of an architecture of the first machine learning model and parameters of the first machine learning model.
Embodiment 19: The processing unit of embodiment 18, wherein the countermeasure circuit is a second machine learning model with parameters based on the parameters of the first machine learning model.
Embodiment 20: The processing unit of any of embodiments 15 to 19, wherein the countermeasure secret is based on an output of a generator component that utilizes the first secret as an input.
Embodiment 21: The processing unit of any of embodiments 15 to 19, wherein the countermeasure secret is based on an output of a generator component that utilizes the information associated with the first secret as an input.
Embodiment 22: The processing unit of embodiment 20, wherein the generator component is at least one of a pseudo-random number generator, a message authentication code function, or a physical unclonable function, or a hash function.
Embodiment 23: The processing unit of any of embodiments 15 to 19, wherein the countermeasure secret is based on an input to the processing unit.
Embodiment 24: The processing unit of embodiment 23, wherein the first secret and the countermeasure secret are configured as a pair.
Embodiment 25: The processing unit of any of embodiments 15 to 24, wherein the processing circuitry is further configured to process the input at a plurality of different countermeasure circuits that are supplied with respective countermeasure secrets.
Embodiment 26: The processing unit of any of embodiments 15-25, wherein the first randomized clock signal and the second randomized clock signal are generated by a single randomized clock circuit.
Embodiment 27: The processing unit of any of embodiments 15 to 18, wherein the first circuit (102) is a cryptographic algorithm and wherein the first secret is a cryptographic key.
Embodiment 28: The processing unit of embodiment 27, wherein the countermeasure circuit is a second cryptographic algorithm, and the countermeasure secret is a cryptographic key.

Those skilled in the art will recognize improvements and modifications to the embodiments of the present disclosure. All such improvements and modifications are considered within the scope of the concepts disclosed herein.

1. A method performed by a processing unit for generating side-channel countermeasures to protect sensitive information, the method comprising:
configuring a first circuit with a first secret;
configuring a countermeasure circuit with a countermeasure secret,
supplying a first randomized clock signal to the first circuit;
supplying a second randomized clock signal to the countermeasure circuit;
processing an input at the first circuit based on the first randomized clock signal and the first secret to generate a first output and a first side-channel leakage; and
processing the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.

2. The method of claim 1, wherein the first circuit and the countermeasure circuit are identical circuits.

3. The method of claim 1, wherein the first circuit and the countermeasure circuit are different circuits and generate respective side-channel leakage profiles that are similar within a predefined threshold.

4. The method of claim 1, wherein the first circuit is a first machine learning model and wherein the first secret is a function of an architecture of the first machine learning model and parameters of the first machine learning model.

5. The method of claim 4, wherein the countermeasure circuit is a second machine learning model with parameters based on the parameters of the first machine learning model.

6. The method of claim 1, wherein the countermeasure secret is based on an output of a generator component that utilizes the first secret as an input.

7. The method of claim 1, wherein the countermeasure secret is based on an output of a generator component that utilizes the information associated with the first secret as an input.

8. The method of claim 6, wherein the generator component is at least one of a pseudo-random number generator, a message authentication code function, or a physical unclonable function, or a hash function.

9. The method of claim 1, wherein the countermeasure secret is based on an input to the processing unit.

10. The method of claim 9, wherein the first secret and the countermeasure secret are configured as a pair.

11-14. (canceled)

15. A processing unit, comprising:
processing circuitry configured to generate side-channel countermeasures to protect sensitive information, wherein the processing circuitry is configured to:
configure a first circuit with a first secret;
configure a countermeasure circuit with a countermeasure secret;
supply a first randomized clock signal to the first circuit;
supply a second randomized clock signal to the countermeasure circuit;
process an input at the first circuit based on the first randomized clock signal and the first secret to generate a first output and a first side-channel leakage; and
process the input at the countermeasure circuit based on the second randomized clock signal and the countermeasure secret to generate a countermeasure output and a countermeasure side-channel leakage, wherein the countermeasure side-channel leakage at least partially obscures the first side-channel leakage.

16. The processing unit of claim 15, wherein the first circuit and the countermeasure circuit are identical circuits.

17. The processing unit of claim 15, wherein the first circuit and the countermeasure circuit are different circuits and generate respective side-channel leakage profiles that are similar within a predefined threshold.

18. The processing unit of claim 15, wherein the first circuit is a first machine learning model and wherein the first secret is a function of an architecture of the first machine learning model and parameters of the first machine learning model.

19. The processing unit of claim 18, wherein the countermeasure circuit is a second machine learning model with parameters based on the parameters of the first machine learning model.

20. The processing unit of claim 15, wherein the countermeasure secret is based on an output of a generator component that utilizes the first secret as an input.

21. The processing unit of claim 15, wherein the countermeasure secret is based on an output of a generator component that utilizes the information associated with the first secret as an input.

22. The processing unit of claim 20, wherein the generator component is at least one of a pseudo-random number generator, a message authentication code function, or a physical unclonable function, or a hash function.

23. The processing unit of claim 15, wherein the countermeasure secret is based on an input to the processing unit.

24. The processing unit of claim 23, wherein the first secret and the countermeasure secret are configured as a pair.

25-28. (canceled)
